(19) United States
(12) Patent Application Publication
(10) Pub. No.: US 2020/0240501 A1
(43) Pub. Date: Jul. 30, 2020

(54) CAMSHAFT FOLLOWER MECHANISM

(71) Applicant: Koyo Bearings North America LLC, Greenville, SC (US)

(72) Inventors: Mark A. Brandolin, Greenville, SC (US); Ronald W. Williamson, Thomasville, GA (US); Michael W. Franklin, Fountain Inn, SC (US)

(21) Appl. No.: 16/741,102

(22) Filed: Jan. 13, 2020

Related U.S. Application Data
(60) Provisional application No. 62/796,929, filed on Jan. 25, 2019.

(51) Int. Cl. F16H 53/06; F01L 1/047; F02F 1/24; F02M 37/06

(52) U.S. Cl. CPC F16H 53/06; F02M 37/06; F02F 1/24; F01L 1/047

(57) ABSTRACT

A follower mechanism including an outer cup having a substantially cylindrical side wall, an annular lip portion disposed at a first end of the side wall, and an annular ledge disposed on the side wall, the annular ledge being disposed in a plane that is transverse to a longitudinal center axis of the follower mechanism. An inner cup includes an annular lip extending outwardly therefrom and a pair of shaft apertures, and is disposed in the outer cup so that the lip abuts the annular ledge of the outer cup and is non-rotatably fixed thereto by the annular lip of the outer cup which abuts the lip of the inner cup. A shaft is received in the shaft apertures, and a roller follower is rotatably received on the shaft such that a portion of the roller follower extends axially outwardly beyond the annular lip portion of the outer cup.

### CLAIM OF PRIORITY

This application claims priority to U.S. provisional patent application No. 62/796,929 filed Jan. 25, 2019, the disclosure of which is incorporated by reference herein.

### FIELD OF THE INVENTION

The present invention relates generally to follower mechanisms. More particularly, the present invention relates to designs and assembly methods of follower mechanisms and their associated alignment devices.

### BACKGROUND OF THE INVENTION

Follower mechanisms are often used in a valve train of an internal combustion engine to transmit motion from a camshaft of the engine to one or more intake or exhaust valves. As the camshaft rotates, the follower mechanisms receive both a sideways force and a downward force from corresponding lobes on the camshaft, but only transmit the downward force to the valves to open and/or close the valves. Follower mechanisms thereby reduce the possibility of bending or otherwise damaging the valve stems of the valves. As well, follower mechanisms are often used in camshaft driven, high-pressure fuel pumps which are used in gasoline direct injection (GDI) systems.

Existing bucket-type follower mechanisms typically include either a stamped or cold formed bucket. A roller follower is typically supported on a shaft that is directly fixed to the bucket such as by staking, swaging, etc. As such, the bucket is a load bearing member and, therefore, requires heat treatment and operations such as grinding. As well, follower mechanisms often have some form of alignment device carried in an aperture defined by the bucket such that rotation of the follower mechanism within the corresponding bore is prevented. One example of known alignment devices is a mushroom-shaped pin that is fixed in an aperture of the follower mechanism's bucket. Such pins can be difficult to manufacture because of their complicated shapes. As well, required heat treatments of the bucket can cause distortion of the aperture which receives the alignment device, thereby complicating assembly. Such alignment devices are often fixed in their corresponding apertures by an interference fit.

The present invention recognizes and addresses considerations of prior art constructions and methods.

### SUMMARY OF THE INVENTION

One embodiment of the present disclosure provides a follower mechanism movable within a bore along a longitudinal center axis of the bore, the mechanism including an outer cup having an inner surface and an outer surface defining a substantially cylindrical side wall, an annular lip portion disposed at a first end of the side wall, and an annular ledge disposed on the inner surface of the side wall, the annular ledge being disposed in a plane that is transverse to a longitudinal center axis of the follower mechanism, an inner cup including an annular lip extending outwardly therefrom and a pair of shaft apertures, the inner cup being disposed in the outer cup so that the lip of the inner cup abuts the annular ledge of the outer cup and is non-rotatably fixed thereto by the annular lip of the outer cup which abuts the lip of the inner cup, a shaft having a first end and a second end, each of the first end and the second end being disposed in a corresponding one of the shaft apertures, and a roller follower rotatably received on the shaft such that a portion of the roller follower extends axially outwardly beyond the annular lip portion of the outer cup.

Another embodiment of the present disclosure provides an internal combustion engine assembly having a cylinder head including a bore, a camshaft rotatably supported within the cylinder head, the camshaft including at least one lobe, a fuel pump including a pump stem, and a follower mechanism slidably disposed within the bore of the cylinder head, the follower mechanism including an outer cup having an inner surface and an outer surface defining a substantially cylindrical side wall, a first annular lip portion disposed at a first end of the side wall, and an annular ledge disposed on the inner surface of the side wall, the annular ledge being disposed in a plane that is transverse to a longitudinal center axis of the follower mechanism, an inner cup including an annular lip extending outwardly therefrom and a pair of shaft apertures, the inner cup being disposed in the outer cup so that the lip of the inner cup abuts the annular ledge of the outer cup and is non-rotatably fixed thereto by the annular lip of the outer cup which abuts the lip of the inner cup, a shaft having a first end and a second end, each of the first end and the second end being disposed in a corresponding one of the shaft apertures, and a roller follower rotatably received on the shaft such that a portion of the roller follower extends axially outwardly beyond the annular lip portion of the outer cup and contacts the at least one lobe of the camshaft, and the pump stem of the fuel pump contacts the inner cup.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIGS. 1A and 1B are perspective views of an embodiment of a follower mechanism in accordance with the present disclosure;

FIG. 2 is an exploded perspective view of the follower mechanism shown in FIGS. 1A and 1B;

FIGS. 3A, 3B, 3C, and 3D are cross-sectional views of the follower mechanism shown in FIGS. 1A and 1B;

FIGS. 4A and 4B are perspective views of an inner cup of the follower mechanism shown in FIGS. 1A and 1B;

FIG. 5 is a perspective view of an outer cup of the follower mechanism shown in FIGS. 1A and 1B; and

FIG. 6 is a partial cross-sectional view of a high pressure fuel pump including the follower mechanism shown in FIGS. 1A and 1B.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

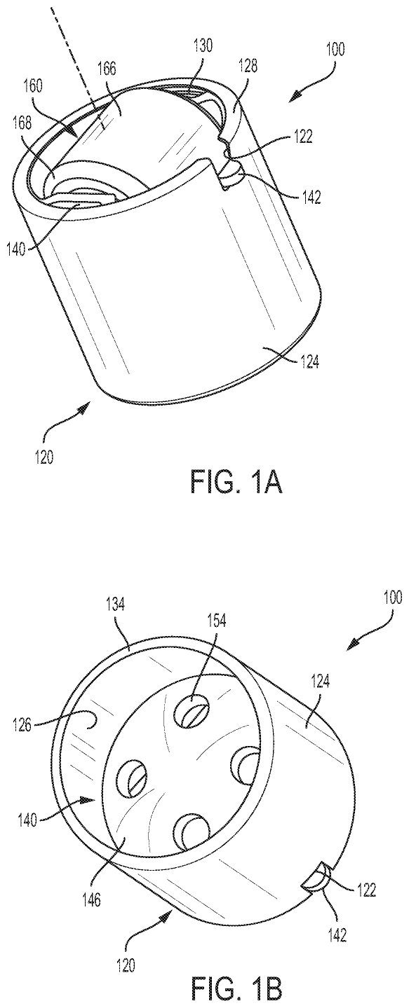

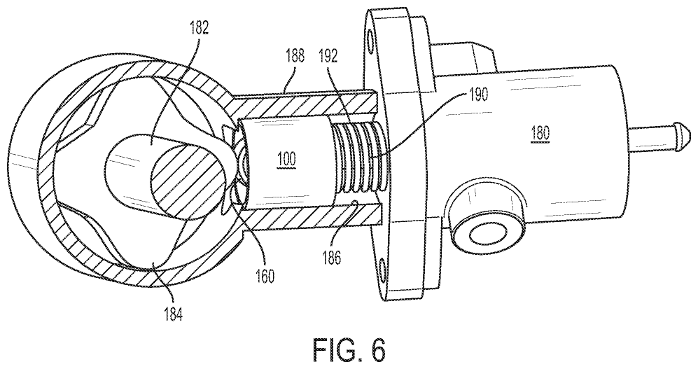

Referring now to the figures, as shown in FIGS. 1A through 3D, an embodiment of a follower mechanism 100 in accordance with the present disclosure includes a substantially cylindrical outer cup 120, an inner cup 140 received therein, a roller follower 160 supported by inner cup 140, and an alignment device 142 extending through a slot 122 formed in outer cup 120. As shown in FIG. 6, follower mechanism 100 is used in a high-pressure fuel pump 180 of an internal combustion engine, although other uses for follower mechanism 100 are possible. As a camshaft 182 of the engine rotates, a lobe 184 of camshaft 182, or a rocker arm (not shown) connected to camshaft 186, engages roller follower 160 of follower mechanism 100 to convert the rotational motion of camshaft 182 into linear motion of follower mechanism 100 within a bore 186 of a corresponding cylinder head 188. A pump stem 190 of pump 180 is positioned within and connected to follower mechanism 100 such that, as follower mechanism 100 moves in a linear direction within bore 186, pump stem 190 is alternatingly moved left (as shown) by spring 192 and right by follower mechanism 100. Forces from camshaft 182 are thereby transmitted through follower mechanism 100 to pump 180 such that only forces in substantially the same direction as the motion of pump stem 190 act on pump 180. In addition, follower mechanism 100 serves as a torsional vibration isolation device between camshaft 182 and pump 180 to inhibit rotational forces from being transmitted. As shown, alignment device 142 (FIG. 1A) is an outwardly extending tab, a portion of which is slidably received in a correspondingly shaped alignment groove (not shown) defined by the inner wall of bore 186.

Referring additionally to FIG. 5, outer cup 120 includes a cylindrical outer surface 124, a cylindrical inner surface 126 substantially concentric therewith, and slot 122 defined in annular lip 128 for slidably receiving alignment device 142. As shown, slot 122 is generally U-shaped having a flat bottom edge 122a. However, bottom edge 122a may also be semi-circular, curved, etc., in shape. Outer cup 120 is preferably formed from a sheet metal blank of low, medium, or high carbon plain or alloy steel by a stamping process, or a deep drawing process using a multi-station transfer or progressive press, in which case slot 122 is preferably formed by piercing, although it may be machined or otherwise cut into outer cup 120. Additionally, outer cup 120 includes an annular lip 128 and 134 formed at each of its opposing ends. Annular lip 128 is thinner in the radial direction than the remaining side wall of outer cup 120, forming an annular ledge 130 therewith. Prior to fully assembling follower mechanism 100, annular lip 128 extends axially outwardly parallel to a longitudinal center axis 132 of outer cup 120, whereas annular ledge 130 lies in a plane that is transverse to longitudinal center axis 132. When forming outer cup 120, annular lip 134 may be initially formed depending radially inwardly as the other components of the roller follower are preferably placed into outer cup 120 from the end at which annular lip 128 is disposed.

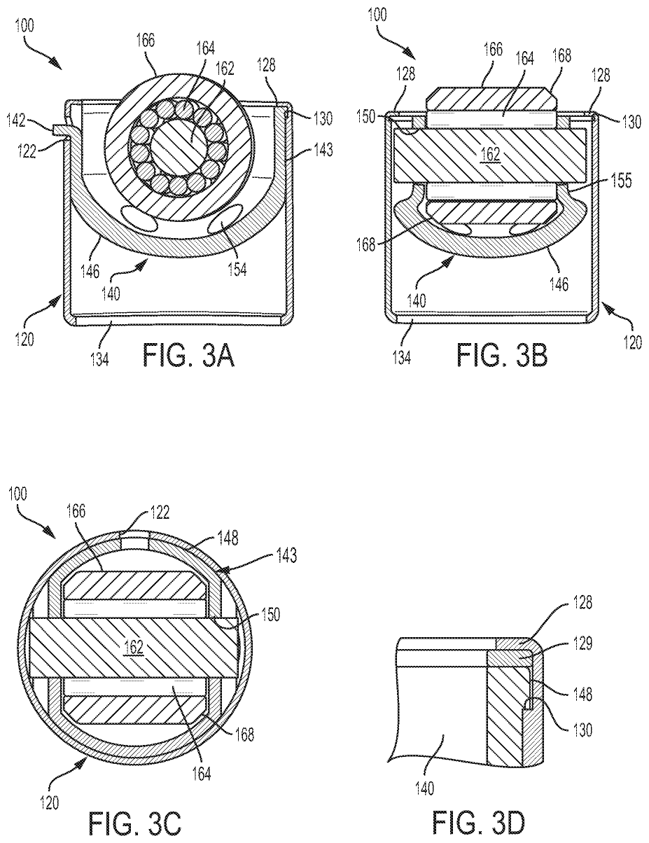

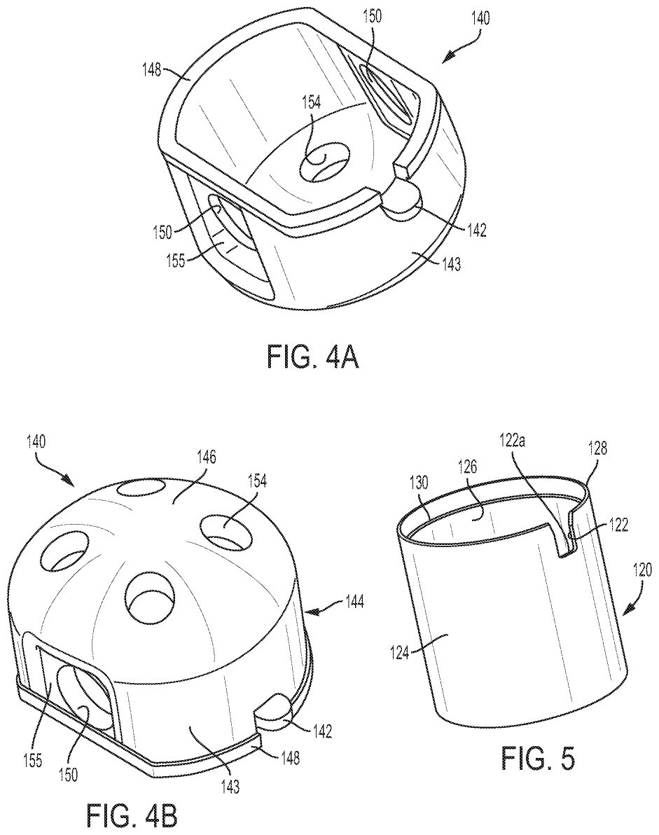

Referring additionally to FIGS. 4A and 4B, inner cup 140 preferably includes a side wall 144 including two opposed curved portions 143 with two parallel side portions 155 extending therebetween, a semi-spherical bottom portion 146, an upper lip 148 extending radially outwardly from an upper perimeter of side wall 144, a pair of shaft apertures 150 defined by side wall 144, and alignment tab 142 extending outwardly from one of the curved portions 143 of the side wall. As best seen in FIGS. 1A, 3A, and 3B, when fully inserted in outer cup 120, upper lip 148 of inner cup 140 rests on annular ledge 130 of outer cup 120 and alignment tab 142 extends outwardly through alignment slot 122. Note, inner cup 140 may be inserted directly into outer cup 120 without tilting since slot 122 is open at the perimeter of annular lip 128 so that alignment tab 142 may be slid directly therein. Note, in alternate embodiments, slot 122 may be replaced with an aperture having a continuous perimeter.

Once fully inserted in outer cup 120 and rotationally positioned by way of alignment tab 142, inner cup 140 is retained therein by folding annular lip 128 over inwardly, such as by crimping, spin curling, punch forming, etc., so that upper lip 148 is non-rotatably squeezed between annular lip 128 and annular ledge 130. Note, as shown in FIG. 3D, in alternate embodiments, a spacer 129 may be positioned between annular lip 128 and annular ledge 130. Spacer 129 helps insure that any potential gaps between lip 128 and ledge 130 are minimized. Spacer 129 is preferably formed from a plastic or a like material. Note, since outer cup 120 does not directly support shaft 162 of roller follower 160, it does not require the heat treatment processes that are typically performed on the outer cups of known follower mechanisms. As such, the folding/crimping operation performed on annular lip 128 is facilitated. However, in those applications where heat treatment of outer cup 120 is desired for wear purposes, the heat treatment process occurs after alignment slot 122 is formed. Next, after the heat treatment process and prior to folding, crimping, etc., annular lip 128 over inwardly, annular lip 128 is tempered to facilitate the operation and help prevent cracking.

Preferably, inner cup 140 is formed from a sheet metal blank by a stamping process, or drawing process, and is subjected to heat treatment processes as it directly supports shaft 162 of follower mechanism 100. Initially, side wall 144 is substantially cylindrical when inner cup 140 is formed. However, prior to the heat treatment process, flat side portions 145 are formed, resulting in the side portions 145 extending between two opposed curved portions 143. As well, prior to the heat treatment processes, shaft apertures 150 are pierced in flat side portions 145 of inner cup 140. Lubrication apertures 154 are also pierced in semi-spherical bottom portion 146 of inner cup 140 prior to any heat treatment processes. As shown, alignment tab 142 includes a rounded distal end that is correspondingly shaped to the alignment groove (not shown) that is formed in the corresponding cylinder head 188 (FIG. 6). Although not shown, similarly to the first embodiment (FIGS. 1A and 1B), a portion of semi-spherical bottom portion 146 may be flattened, thereby forming a bottom wall that is perpendicular to longitudinal center axis 132 of follower mechanism 100.

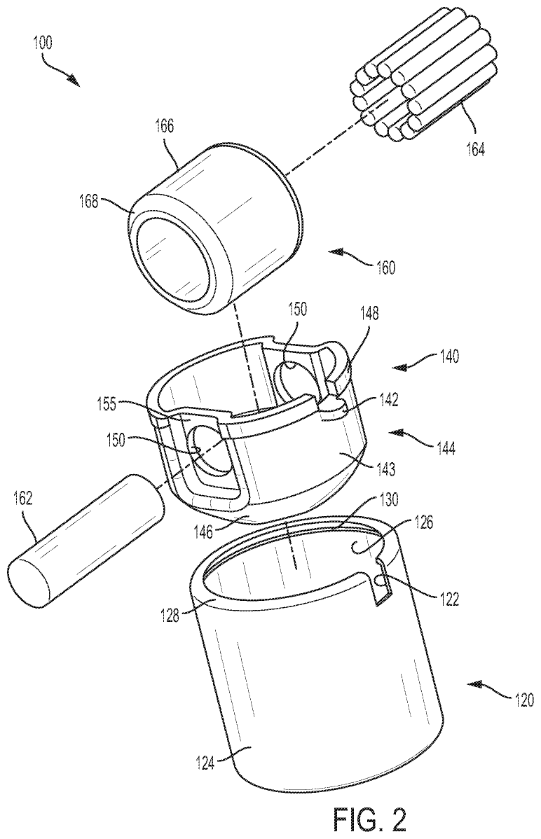

As best seen in FIG. 2, roller follower 160 includes shaft 162, an outer race 166, and a plurality of rollers 164 disposed therebetween such that race 166 is freely rotatable about shaft 162. Opposite ends of shaft 162 are received in shaft apertures 150 of inner cup 140. When assembled, roller follower 160 extends axially-outwardly beyond the top edge of outer cup 120 such that outer surface of race 166 engages a corresponding lobe 184 of camshaft 182, as shown in FIG. 6. Preferably, the diameters of shaft apertures 150 are slightly larger than the diameter of shaft 162 so that shaft 162 is free to rotate therein. Alternately, the opposing ends of shaft 162 can be staked, swaged, etc., to inner cup 140 such that rotation relative thereto is prevented. Note, when shaft 162 is free to rotate within shaft apertures 150, the axial motion of shaft 162 is limited by abutment at either end with inner surface 126 of outer cup 120. Note, unlike the previously discussed embodiment, the flat inner surfaces of parallel side portions 155 of inner cup 140 negate the need for washers at opposite ends of rollers 164. Preferably, annular beveled edges 168 are provided on the opposite ends of outer race 166 to allow the overall size of outer race 166 to be maximized, yet not make contact with the rounded bottom corners of inner cup 140.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A follower mechanism movable within a bore along a longitudinal center axis of the bore, comprising:
an outer cup having an inner surface and an outer surface defining a substantially cylindrical side wall, a first annular lip portion disposed at a first end of the side wall, and an annular ledge disposed on the inner surface of the side wall, the annular ledge being disposed in a plane that is transverse to a longitudinal center axis of the follower mechanism;
an inner cup including an annular lip extending outwardly therefrom and a pair of shaft apertures, the inner cup being disposed in the outer cup so that the lip of the inner cup abuts the annular ledge of the outer cup and is non-rotatably fixed thereto by the annular lip of the outer cup which abuts the lip of the inner cup;
a shaft having a first end and a second end, each of the first end and the second end being disposed in a corresponding one of the shaft apertures; and
a roller follower rotatably received on the shaft such that a portion of the roller follower extends axially outwardly beyond the annular lip portion of the outer cup.

2. The follower mechanism of claim 1, wherein the roller follower further comprises
a plurality of rollers and an outer race,
wherein the plurality of rollers is disposed between an outer surface of the shaft and an inner surface of the outer race.

3. The follower mechanism of claim 1, further comprising:
a slot defined in the first annular lip of the outer cup, the slot extending downwardly from an upper perimeter of the first annular lip; and
an alignment device extending outwardly from a side wall of the inner cup,
wherein the alignment device extends through the slot of the outer cup.

4. The follower mechanism of claim 3, wherein the alignment device is a tab.

5. The follower mechanism of claim 3, wherein the side wall of the inner cup includes two opposed curved portions and two parallel side portions extending therebetween, the alignment device extending outwardly from a corresponding one of the curved portions.

6. An internal combustion engine assembly, comprising:
a cylinder head including a bore;
a camshaft rotatably supported within the cylinder head, the camshaft including a lobe;
a fuel pump including a pump stem; and
a follower mechanism slidably disposed within the bore of the cylinder head, comprising:
an outer cup having an inner surface and an outer surface defining a substantially cylindrical side wall, a first annular lip portion disposed at a first end of the side wall, and an annular ledge disposed on the inner surface of the side wall, the annular ledge being disposed in a plane that is transverse to a longitudinal center axis of the follower mechanism;
an inner cup including an annular lip extending outwardly therefrom and a pair of shaft apertures, the inner cup being disposed in the outer cup so that the lip of the inner cup abuts the annular ledge of the outer cup and is non-rotatably fixed thereto by the annular lip of the outer cup which abuts the lip of the inner cup;
a shaft having a first end and a second end, each of the first end and the second end being disposed in a corresponding one of the shaft apertures; and
a roller follower rotatably received on the shaft such that a portion of the roller follower extends axially outwardly beyond the annular lip portion of the outer cup and contacts the lobe of the camshaft, and the pump stem of the fuel pump contacts the inner cup.

7. The internal combustion engine assembly of claim 6, wherein the roller follower further comprises
a plurality of rollers and an outer race,
wherein the plurality of rollers is disposed between an outer surface of the shaft and an inner surface of the outer race.

8. The internal combustion engine assembly of claim 6, further comprising:
a slot defined in the first annular lip of the outer cup, the slot extending downwardly from an upper perimeter of the first annular lip; and
an alignment device extending outwardly from a side wall of the inner cup,
wherein the alignment device extends through the slot of the outer cup.

9. The internal combustion engine assembly of claim 6, wherein the alignment device is a tab.

10. The internal combustion engine assembly of claim 6, wherein the side wall of the inner cup includes two opposed curved portions and two parallel side portions extending therebetween, the alignment device extending outwardly from a corresponding one of the curved portions.

11. A follower mechanism movable within a bore along a longitudinal center axis of the bore, comprising:
an outer cup having a first send, a second end, and a side wall with an inner surface and an outer surface extending therebetween, a first annular lip portion disposed at the first end of the side wall, and an annular ledge disposed on the inner surface of the side wall, the annular ledge being disposed in a plane that is transverse to a longitudinal center axis of the follower mechanism;
an inner cup including an annular lip extending outwardly therefrom and a pair of shaft apertures, the inner cup being disposed in the outer cup so that the lip of the inner cup abuts the annular ledge of the outer cup and the annular lip of the outer cup abuts the lip of the inner cup;
a shaft having a first end and a second end, each of the first end and the second end being disposed in a corresponding one of the shaft apertures; and
a roller follower rotatably received on the shaft such that a portion of the roller follower extends axially outwardly beyond the annular lip portion of the outer cup.

12. The follower mechanism of claim 11, wherein the roller follower further comprises
a plurality of rollers and an outer race,
wherein the plurality of rollers is disposed between an outer surface of the shaft and an inner surface of the outer race.

13. The follower mechanism of claim 11, further comprising:
a slot defined in the first annular lip of the outer cup, the slot extending downwardly from an upper perimeter of the first annular lip; and
an alignment device extending outwardly from a side wall of the inner cup,
wherein the alignment device extends through the slot of the outer cup.

14. The follower mechanism of claim 13, wherein the alignment device is a tab.

15. The follower mechanism of claim 13, wherein the side wall of the inner cup includes two opposed curved portions and two parallel side portions extending therebetween, the alignment device extending outwardly from a corresponding one of the curved portions.
